(19) United States
(12) Patent Application Publication
(10) Pub. No.: US 2022/0304257 A1
(43) Pub. Date: Sep. 29, 2022

(54) INFORMATION PROCESSING DEVICE, STORAGE MEDIUM, AND INFORMATION PROCESSING METHOD

(71) Applicant: CANON KABUSHIKI KAISHA, Tokyo (JP)

(72) Inventors: Seiichi Hiromitsu, (US); Katsuhisa Abe, Chiba (JP); Soichiro Nakada, Saitama (JP); Azusa Matsumoto, Kanagawa (JP)

(21) Appl. No.: 17/837,130

(22) Filed: Jun. 10, 2022

Related U.S. Application Data
(63) Continuation of application No. PCT/JP2020/047227, filed on Dec. 17, 2020.

(30) Foreign Application Priority Data
Dec. 19, 2019 (JP) 2019-228793
Dec. 19, 2019 (JP) 2019-228800

(51) Int. Cl. A01G 22/20; G06T 7/60; G06T 7/90; G06T 7/00; G06T 11/20

(52) U.S. Cl. CPC A01G 22/20; G06T 7/60; G06T 7/90; G06T 7/0012; G06T 11/206; G06T 2207/30188; G06T 2207/30242

(57) ABSTRACT

An information processing device includes: image acquisition unit for acquiring an image of a crop; index data generation unit for generating first growth index data and second growth index data different from the first growth index data based on images of the crop acquired at a plurality of different times; and display data generation unit for generating display data for displaying a first growth process of the crop generated based on the first growth index data and a second growth process of the crop generated based on the second growth index data.

### BACKGROUND OF THE INVENTION

### Field of the Invention

The present invention relates to an information processing device and the like appropriate for supporting farm work.

### Description of the Related Art

In agriculture of the related art, growth situations of crops have been determined traditionally based on experience, knowledge, and intuition of agricultural workers. On the other hand, systems that acquire information of environmental sensors, image data, or the like using Internet of Things (IoT) technologies and determine growth situations have recently been considered.

In such systems, however, the acquired image data or the like has been determined comprehensively in the end by agricultural workers and accumulations of the acquired data has not been sufficiently utilized or shared as useful data.

Japanese Patent Application Laid-open No. 2019-165655 discloses an environmental information sensor that is installed in a plantation where crops are cultivated and acquires environmental information indicating an environment in the plantation and an imaging device that is installed in the plantation and captures images of the crops.

Japanese Patent Application Laid-open No. 2019-165655 also discloses a determination device that determines residual integrated values which are integrated values of predetermined environmental values until appropriate harvest of the crops based on the environmental information and image information which is information obtained from images of the crops.

In the technology of Japanese Patent Application Laid-open No. 2019-165655, however, harvest times are merely determined, and detailed information for realizing optimum growth in growth of crops is insufficient. Accordingly, growth situations change depending on a situation of weather or the like, but it has not been considered which countermeasures against such changes in the growth situations are optimum.

In addition, Japanese Patent Application Laid-open No. 2019-165655 does not disclose an information processing device appropriate for supplying information useful for agriculture or the like.

One of objects of the present invention is to solve the above described problem, and to make possible to supply information useful for growth situations or the like of crops.

### SUMMARY OF THE INVENTION

According to an aspect of the present invention, an information processing device includes: image acquisition unit configured to acquire an image of a specific crop in a field; environmental information acquisition unit configured to acquire environmental information data regarding an environment of the field; index data generation unit configured to generate growth index data of the crop based on the image of the crop acquired by the image acquisition unit; accumulation unit configured to accumulate the growth index data of a plurality of dates and times generated by the index data generation unit and the environmental information data of the plurality of dates and times; and display data generation unit configured to generate display data for displaying a growth process based on the growth index data of the plurality of dates and times and the environmental information data of the plurality of dates and times accumulated in the accumulation unit.

Further features of the present invention will become apparent from the following description of embodiments with reference to the attached drawings.

### BRIEF DESCRIPTION OF THE DRAWINGS

FIG. 1 is a diagram illustrating an overall configuration of a system in which an information processing device is used according to a first embodiment.

FIG. 2 is a functional block diagram illustrating an image analysis cloud server.

FIG. 3 is a flowchart illustrating an operation flow in which a control server serves as a center.

FIG. 4 is a diagram illustrating an example of a display screen based on display data generated in an application server.

FIG. 5 is a diagram illustrating another example of the display screen.

FIG. 6 is a diagram illustrating still another example of the display screen.

FIG. 7 is a diagram illustrating an example of a flowchart for association.

FIG. 8 is a diagram illustrating the continued example of the flowchart for association.

FIG. 9A and FIG. 9B are diagrams illustrating examples of tables or the like in which the association is performed.

### DESCRIPTION OF THE EMBODIMENTS

Hereinafter, embodiments of the present invention will be described with reference to the drawings. However, the present invention is not limited to the following embodiments. In the drawings, the same reference numerals are given to the same members or elements and repeated description thereof will be omitted or simplified.

### First Embodiment

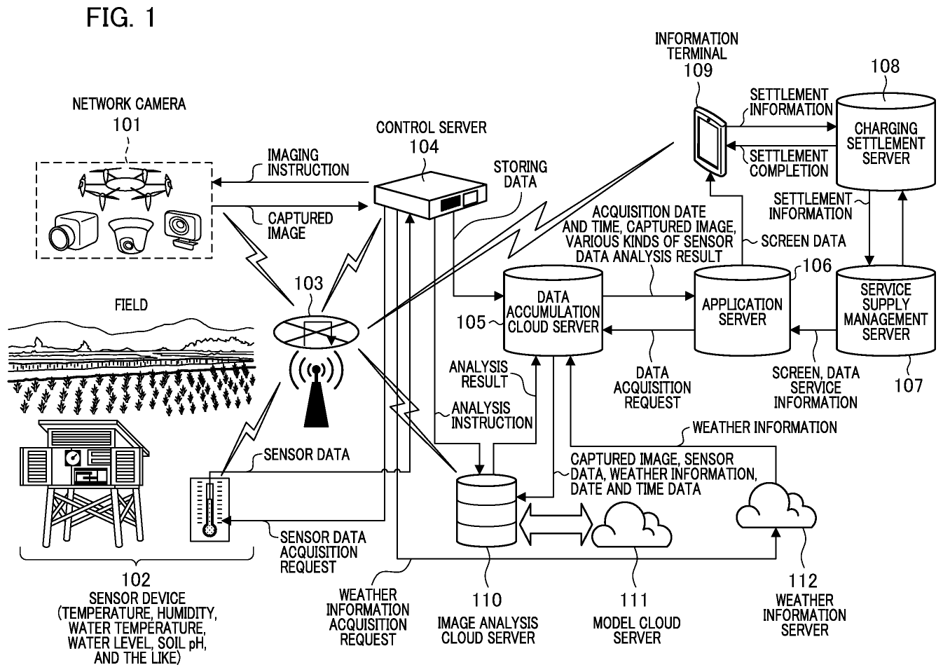

FIG. 1 is a diagram illustrating an overall configuration of a system in which an information processing device according to a first embodiment is used.

Hereinafter, an overall configuration of the system in which the information processing device according to the first embodiment is used will be described with reference to FIG. 1.

The system in which the information processing device according to the first embodiment is used includes a network camera 101, a plurality of sensor devices 102, a network (a public line) 103, a control server 104, a data accumulation cloud server 105, and an application server 106.

The system includes a service supply management server 107, a charging settlement server 108, an information terminal 109 such as a tablet or the like of a service contractor, an image analysis cloud server 110, a model cloud server 111 that learns a growth situation, and a weather information server 112.

In the first embodiment, an example of a server or a cloud server is used in description. However, it need not have the form of the server or the cloud server. For example, an electronic device that has a function similar to a function of each server or cloud server may be used.

In the first embodiment, the information processing device is a device that has at least a function of the control server 104. Further, the information processing device may be a device that has some or all of the functions of the other servers 105 to 108, 110, and 111.

The network camera 101 may be a fixed camera or may be a camera mounted on a drone, and has a network interface for transmitting captured images to the control server 104 or the like via the wired or wireless network 103.

The network camera 101 receives control signals such as an imaging instruction from the control server 104 via the network 103, and ON/OFF control, an imaging operation, transmission of a captured image to the control server, and the like are performed based on the control signals. Here, the network camera 101 functions as image acquisition unit for acquiring an image of a specific crop in a field. The image acquisition unit includes, for example, a reading device that reads an image of a specific crop recorded in advance on a recording medium to acquire the image.

A CPU serving as a computer is embedded in the control server 104 and functions as control unit for controlling operations of the network camera, the sensor devices, and other devices in the system based on a computer program stored in a memory. In the first embodiment, when the area of a field of a crop is large, the number of installed network cameras 101 or the number of installed sensor devices 102 may be plural.

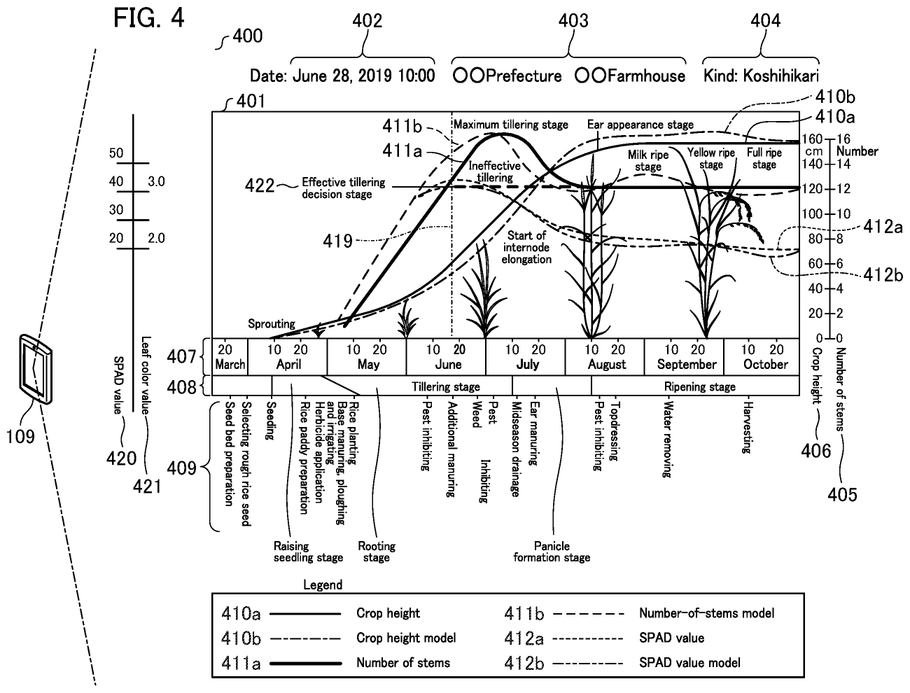

In the first embodiment, an example in which rice which is a target (a crop) is cultivated as a crop will be described, but the same can similarly apply to other plants of Gramineae. Examples of plants (crops) of Gramineae include rice, wheat, barley, millet, Setaria italica, Japanese millet, and corn. The first embodiment can be applied not only to plants of Gramineae but also spinach cultivated in an open field, or the like. As will be described below, at least one network camera 101 is configured to image a crop at a predetermined position of a field from above, as illustrated in a form of the field in FIG. 4.

The network camera 101 may be a camera mounted on a drone and may image a crop, for example, at a plurality of predetermined positions (sample positions) of a field from above using the drone. A crop height may be obtained by performing ranging based on right and left captured images at the time of imaging from above using a stereo camera or the like. For example, a stereo camera or the like which is a camera capable of performing ranging may be mounted on a drone or a mobile robot to perform imaging and ranging from the upper side of a fixed point.

The network 103 may be a wired LAN or a wireless LAN. In the first embodiment, the network 103 may be assumed to be a wireless LAN.

The network 103 may be a mobile communication network provided by a communication service provider. In this case, a SIM card is inserted into a card adapter in the body of the network camera 101 so that connection to a public line network is possible.

The plurality of sensor devices 102 are connected to the control server 104 via the network 103 and each sensor device transmits sensor data to the control server 104 in response to a sensor data acquisition request from the control server 104. Alternatively, each sensor device may be configured to transmit the sensor data to the control server 104 at each different timing and at a predetermined transmission interval in conformity with a low power wide area (LPWA) communication standard or the like.

In this case, the control server 104 may select the sensor data transmitted at a desired timing among the data transmitted from the sensor devices at a predetermined cycle. The sensor devices 102 according to the first embodiment include a plurality of types of sensor devices and function as environmental information acquisition unit for acquiring environmental information data regarding an environment of a field. Specifically, for example, data regarding latitude and longitude (or altitude) of a field can be acquired. Further, a sensor device that acquires environmental information data regarding an environment of soil of a field is included.

The sensor devices acquiring data regarding latitude and longitude (or altitude) of a field include, for example, GPS sensors or the like. The sensor devices may be disposed at a plurality of positions of the field or may be disposed inside the network camera 101. Each network camera 101 has a camera ID (camera identification information) serving as unique identification information. The camera ID is displayed as text, a QR code (registered trademark), or the like on the outside of the casing of the network camera 101.

Similarly, each sensor device 102 has a sensor ID (sensor identification information) serving as unique identification information. In the first embodiment, the sensor ID is displayed as text, a QR code (registered trademark), or the like on the outside of the casing of the sensor device 102.

It is desirable to link (i.e. correlate) or pair the network cameras 101 and the sensor devices 102 in advance.

As a specific method, for example, the sensor ID formed from text, a QR code (registered trademark), or the like displayed on the outside of the casing the sensor device 102 is imaged by the network camera 101. Accordingly, the imaged sensor ID of the sensor device 102 can be subjected to image recognition to be correlated with the imaged camera ID of the network camera 101.

At this time, for example, the recognized sensor ID of the sensor device 102 is written in a header region of the image captured by the network camera 101.

Accordingly, when the image captured by the network camera 101 is transmitted to the control server 104, the sensor ID of the sensor device 102 can be correlated with the camera ID of the network camera 101. Here, unit for performing writing in the header region of such an image file functions as correlating unit.

Alternatively, the network camera 101, the sensor device 102, or the control server 104 may have application software in advance. A user may correlate and register the sensor ID of the sensor device 102 and the camera ID of the network camera 101 on a screen of the application software.

In that case, the camera ID and the sensor ID may not be displayed on the outside of each casing. In this case, the application software with which the user performs setting to correlate the camera identification information and the sensor identification information functions as correlating unit.

Alternatively, the camera ID of the network camera 101 and the sensor ID of the sensor device 102 may be imaged simultaneously or sequentially with a separate camera provided in a smartphone or the like.

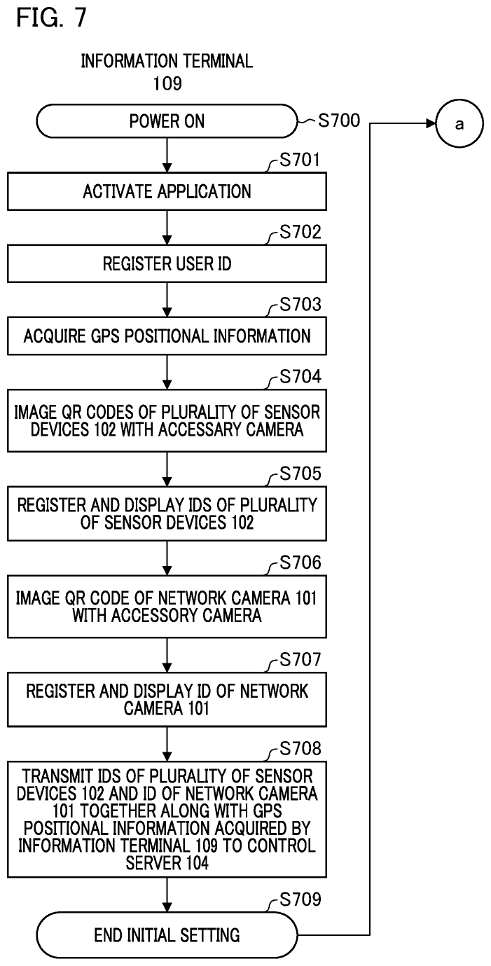

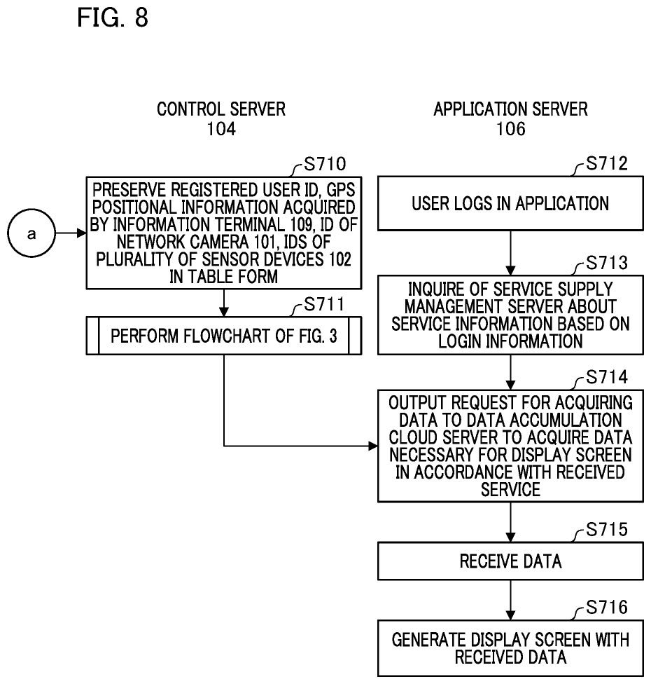

By transmitting the images to the control server 104, it is also possible to correlate (i.e. link) and register the camera ID of the network camera 101 and the sensor ID of the sensor device 102. The flows of FIGS. 7 and 8 which are detailed flowcharts in the pairing (correlating or linking) method will be described below.

As a method of correlating the camera ID and the sensor ID, for example, the pairing may be performed using Bluetooth (registered trademark), NFC, or the like instead of the method of imaging the text ID, the QR code (registered trademark), or the like displayed on the outside of the casing and recognizing the images, as described above.

By performing the pairing in advance, for example, it is possible to use a table in the control server for management by linking (associating) the sensor data of the sensor device correlated in advance with the image captured by a specific camera among the plurality of network cameras.

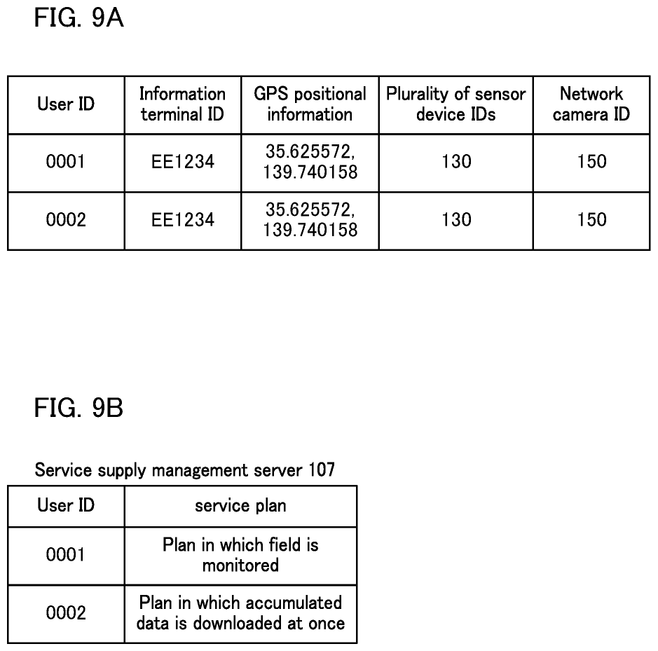

FIGS. 7 and 8 are flowcharts illustrating an example of a paring method. FIG. 9 is a diagram illustrating an example of a table in which the association is performed. FIGS. 7 to 9 will be described below.

The correlated sensor data of the sensor device can be efficiently recorded in a header region of an image file of images captured by, for example, the specific network camera 101. Accordingly, when there are many network cameras 101 and sensor devices 102, the image data and the sensor data can be efficiently associated.

The sensor data of the sensor device is written in a header region which is separate from that of the same image file and is correlated by writing the correlated ID of the sensor device in a part of the header region of the image file.

The environmental information data regarding the environment of the soil of the field measured by the sensor device 102 is data acquired with regard to at least one of, for example, a color of the soil, an amount of moisture of the soil, amounts or proportions of a plurality of predetermined chemical substances (for example, nitrogen, phosphoric acid, potassium, and the like) in the soil, and a pH value of the soil.

The sensor device 102 may be configured to be able to acquire some data regarding weather information of the field. That is, the sensor device 102 may be configured to be able to detect (measure) data regarding at least one of, for example, an altitude of a field, an amount of precipitation, an amount of rainfall, an amount of snowfall, a temperature, humidity, a water level of a field such as a rice paddy, a water temperature of a field such as a rice paddy, illuminance, a sunshine duration, a wind speed, and an atmospheric pressure.

The data accumulation cloud server 105 is a cloud server that accumulates data based on instructions from the control server 104.

Image data (image files) from the network cameras 101 and sensor data from the sensor devices 102 are accumulated (stored) to be linked with data of acquisition dates and times. Here, the linking includes linking (association) by writing (storing) each kind of data in a header region of an image file. The data of the dates and times may be acquired from, for example, a CPU or the like inside the network camera 101 or may be acquired from the sensor device 102. Alternatively, the data of the dates and times may be acquired from a CPU or the like inside the data accumulation cloud server 105. The data accumulation cloud server 105 also acquires weather data of dates and times at which the images are captured from the weather information server 112.

The data accumulation cloud server 105 transmits the captured images and the sensor data from the network camera 101 and weather information data from the weather information server 112 to the image analysis cloud server 110 based on instructions from the control server 104.

The image analysis cloud server 110 performs image analysis on an image from the network camera 101 based on an instruction from the control server 104.

The model cloud server 111 statistically learns a relation of growth situations with past images of the crop, growth index data, environmental information data (sensor data, weather data, and the like), dates and times, and the like. Growth model data in which the images, the growth index data, the environmental information data, the dates and times, and the like are associated with the growth situations by learning is generated and preserved.

The image analysis cloud server 110 acquires the growth model data in which the past growth index data and the environmental information data are linked from the model cloud server 111.

The image analysis cloud server 110 analyzes an image of a crop obtained by the network camera 101 and generates the growth index data of the crop as an analysis result. Further, the image analysis cloud server 110 generates the growth index data of the crop by comparing/referring to the growth index data, the environmental information data (sensor data, weather information data, and the like), and date and time data with the growth model data.

That is, the image analysis cloud server 110 functions as index data generation unit for generating the growth index data. In particular, the image analysis cloud server 110 functions as (growth stage) data generation unit for generating information regarding each growth stage (for example, a tillering stage or the like).

The growth index data (an analysis result) generated by the image analysis cloud server 110 is transmitted to the data accumulation cloud server 105 and is accumulated by linking (associating) the growth index data with the image, the sensor data, the weather data, and the dates and times.

At this time, the growth index data, the sensor data, the weather data, the dates and times, and the like are each written to be accumulated (stored) in predetermined header regions of an image file of the crop. For example, the growth index data, the sensor data, the weather data, the dates and times, and the like are written in the header regions of the image file determined in conformity with an exchangeable image file format (EXIF).

For example, it is desirable to perform the writing in a region called a Maker Note in the header region of the EXIF standard, where a data type is UNDEFINED and a data structure or size is not regulated. The growth index data, the sensor data, the weather data, the dates and times, and the like may be allocated to be written in each header region.

When communication is performed using a separate data platform rather than the header regions of the image file, an API format determined in conformity with the WAGRI standard may be used. Here, API is an abbreviation for application programming interface. Thus, mutual availability such as coordination, sharing, supply, or the like of the growth index data, the sensor data, and the weather data may be possible.

Here, WAGRI is a name of agricultural data collaboration platform. Hereinafter, an example of a case in which the header regions of the image file is used will be described here.

The data accumulation cloud server 105 functions as accumulation unit for accumulating image data of a plurality of dates and times, growth index data, environmental information data of a plurality of dates and times, weather information, and the like generated by the index data generation unit in association with each piece of date and date data.

Information or the like regarding captured image data of a crop, growth index data, and environmental information data of a plurality of dates and times, and acquisition dates and times temporarily accumulated in the data accumulation cloud server 105 is transmitted to the application server 106.

The application server 106 generates display data for displaying the information regarding a growth process (a growth stage) in a graph form based on the growth index data of the plurality of times and times and the environmental information data of the plurality of dates and times. The application server 106 functions as display data generation unit or growth stage data generation unit therefor.

The weather information server 112 transmits weather information as environmental information data to the data accumulation cloud server 105 in response to a weather information acquisition request from the control server 104.

The weather information includes, for example, data regarding at least one of weather, an amount of precipitation, an amount of rainfall, an amount of snowfall, a temperature, humidity, a sunshine duration, a wind speed, and an atmospheric pressure.

As described above, a part of the weather information can also be acquired from the sensor device 102. The weather information server 112 also functions as a part of the environmental information acquisition unit for acquiring the environmental information data regarding the environment (weather) of the field.

Reference numeral 107 denotes a service supply management server that transmits information indicating which display screen, data, and service is supplied to a contractor (a contract user) to the application server 106 based on charging settlement information from the charging settlement server 108. Information regarding charging service content is transmitted to the charging settlement server 108.

A charging settlement server 108 communicates with the information terminal 109 of the contractor, acquires settlement information of charging for the contractor from the information terminal 109 of the contractor, and transmits information regarding whether settlement is completed to the information terminal 109 of the contractor.

Here, the service supply management server 107, the charging settlement server 108, and the application server 106 function as charging settlement unit capable of supplying the accumulated growth index data and environmental information data to a predetermined terminal in accordance with charging.

The service supply management server 107, the charging settlement server 108, and the application server 106 also function as charging settlement unit capable of supplying the predetermined terminal with data regarding a growth process generated based on the growth index data of the plurality of dates and times and the environmental information data of the plurality of dates and times in accordance with charging.

When settlement information is transmitted from the information terminal 109 of the contractor to the charging settlement server 108, the settlement information is transmitted to the service supply management server 107. Then, based on the settlement information (whether payment is complemented or the like), a screen, data, and service information is transmitted to the application server 106.

The application server 106 transmits display data for displaying the growth process in a graph form accordingly to the information terminal 109 of the contractor so that a display screen in which the growth process is formed in the graph form can be displayed on the information terminal 109 of the contractor. It is needless to say that the cloud servers 105 to 108 and 110 to 112 or the information terminal 109 include a computer.

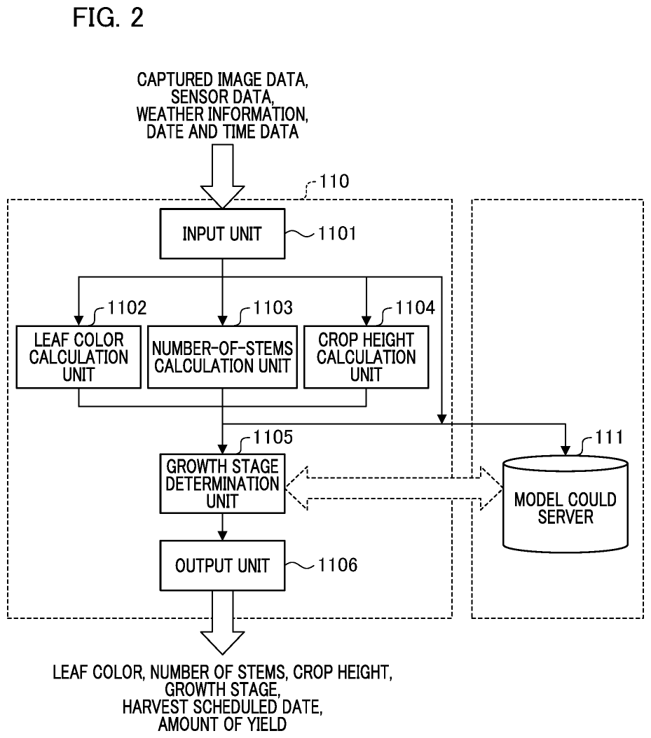

FIG. 2 is a functional block diagram illustrating the image analysis cloud server 110. A function of the image analysis cloud server 110 will be described with reference to FIG. 2.

Reference numeral 1101 denotes an input unit that acquires captured image data, various kinds of sensor data, weather information data, date and time data at which each piece of data is acquired, and the like from the data accumulation cloud server 105.

Reference numeral 1102 denotes a leaf color calculation unit that calculate a color of a leaf of the crop. A color of ears may also be calculated. Reference numeral 1103 denotes a number-of-stems calculation unit that calculates the number of stems of the crop.

The leaf color may be converted and expressed in units of a solid and plant analyzer development (SPAD) value said to be correlated to a chlorophyll content within a predetermined range under a predetermined condition.

To calculate the number of stems in the field from an image, in the first embodiment, apexes of leaves (leaf apexes) are learned and are recognized with artificial intelligence (AI) using the apexes of the leaves as dots, the number of apexes of the leaves (leaf apexes) is counted, and the number of stems is calculated based on the number of leaf apexes.

This is because it is possible to find out a predetermined correlation between the number of stems and the number of apexes of the leaves in accordance with past statistical data (training data).

For example, about ⅓ of the number of leaves can be calculated statistically as the number of stems. Reference numeral 1104 denotes a crop height calculation unit that calculates a crop height (a maximum height of a crop from the ground).

For example, one network camera 101 is disposed on the lateral side of the crop and can calculate the crop height (a maximum height of the crop from the ground) by imaging the crop along with a reference scale installed on the lateral side of the crop.

In the first embodiment, data regarding the leaf color, the number of stems, and the crop height is used as main growth index data of the crop. Further, for example, a vegetation rate per unit area may be included as growth index data.

In the case of a crop of Gramineae, data regarding at least one of a proportion of stems on which ears appear to the number of stems, a proportion of ears that turn yellow, the number of ears, the number of grains of rough rice per ear, inclinations of the stems, and the degree of bending of the stems may be included. By increasing kinds of growth index data, it is possible to improve accuracy at the time of displaying a growth process in a graph form.

A state calculated from a swelling or color of rough rice or the degree of maturement may be included in the growth index data. Thus, a ratio of perfect grains can be indicated. Here, a ratio of perfect grains represents in percentage how many well-ordered grain, that is, rice grains each having an ordered excellent shape, are present in a specific amount of unmilled rice.

The growth index data of the leaf color calculation unit 1102, the number-of-stems calculation unit 1103, the crop height calculation unit 1104, and the like or the sensor data, the weather information data, the date and time data from the input unit 1101 are supplied to a growth stage determination unit 1105.

The data is also supplied and preserved in the model cloud server 111 that learns a growth situation and is used as training data.

The growth stage determination unit 1105 compares the growth index data such as the leaf color, the number of stems, and the crop height, the sensor data, the weather information data, the date and time data, and the like with growth model data of the model cloud server 111.

Accordingly, a growth stage (a growth process) at the time of capturing of images of the crop is determined. Further, referring to the growth model data of the model cloud server 111, an expected value of a yield per unit area or a preferable harvest scheduled date is also calculated.

The growth index data such as the leaf color, the number of stems, and the crop height, the growth stage data, the harvest scheduled date, an amount of yield per unit area, and the like are output as an analysis result to the data accumulation cloud server 105 via an output unit 1106.

FIG. 4 illustrates an example of a display screen based on display data generated in the application server 106.

The application server 106 generates display data for displaying the growth process in a graph form based on the growth index data of a plurality of dates and times and the environmental information data of the plurality of dates and times accumulated in the data accumulation cloud server 105.

Further, display data for displaying the growth process and also displaying at least one of an image of the field and an image of the crop on a predetermined date and time may be generated.

Display data for displaying the growth process and also displaying at least one of a harvest time and an expectation of an amount of yield per unit area may be generated. Display data for displaying information regarding the growth stage (for example, a tillering stage or the like) of the crop may be generated along with the display data of the growth process.

The display data is displayed in a graph form, as illustrated in FIG. 4, for example, on the information terminal 109. Display content of FIG. 4 will be described below.

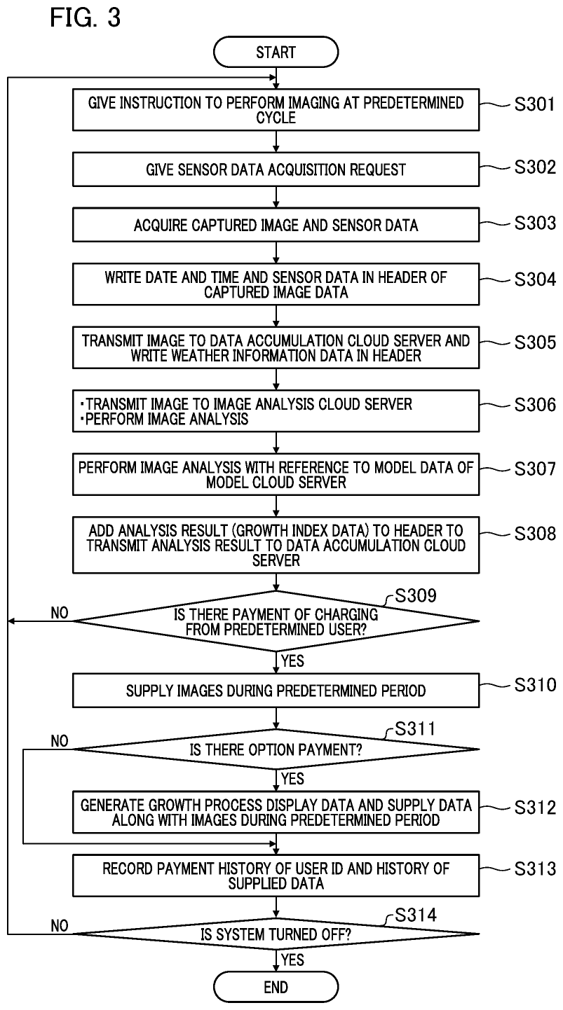

Next, an operation flow in which the control server 104 serves as a center will be described with reference to FIG. 3. FIG. 3 is a flowchart illustrating the operation flow in which the control server serves as a center.

In the system illustrated in FIG. 1, the control server 104 or the like is activated to start the flow of FIG. 3. In step S301, the network cameras 101 are used to image the field at a predetermined cycle. For example, a predetermined cycle such as “acquisition at every morning 10:00” is set in advance in the control server 104 through an application of the information terminal 109.

In step S302, a data acquisition request is transmitted to the sensor device 102. In step S303, a captured image and sensor data are acquired as results of steps S301 and S302. In step S304, an imaging date and time and the sensor data are written as metadata in predetermined header regions of the captured image data.

In step S305, the captured image data in which the data is written in the header is transmitted to the data accumulation cloud server 105, and weather information data from the weather information server 112 is written in another header region of the captured image data.

In step S306, the image data in which various kinds of data are written in the header is transmitted and an instruction to perform image analysis is given to the image analysis cloud server 110. In step S307, the image analysis cloud server 110 performs the image analysis by comparing/referring to the growth model of the model cloud server 111.

In step S308, the growth index data which is a result analyzed by the image analysis cloud server 110 is further added to the header region of the image to be transmitted to the data accumulation cloud server 105.

Thus, each of the date and time, environmental data (sensor data), and the growth index data is written in each header region of the image file to be accumulated in the data accumulation cloud server 105. In step S309, it is determined whether there is payment of charging from a predetermined contract user. When there is the payment, the process proceeds to step S310.

When there is no payment, the process returns to step S301 to continue the accumulation of data. In step S310, an instruction is given to the application server 106 so that images during a predetermined period are supplied to the contract user performing the payment of the charging.

At this time, some or all of the above-described plurality of pieces of data written in the header regions of the image are supplied. Some of the data written in the header regions may be masked and supplied in accordance with an amount of charging.

In step S311, it is determined whether there is payment of an option fee as the charging. In the case of NO, the process proceeds to step S313. In the case of YES, the process proceeds to step S312.

In step S312, the application server 106 is caused to generate display data for displaying the growth process and is caused to supply the contract user with the display data for displaying the growth process along with the images during the predetermined period.

In step S313, an ID (an identification number) of the contract user, a payment history, and a history of the supplied data or the like are preserved in the charging settlement server 108.

In step S314, it is determined whether the system of FIG. 1 is turned off. When the system is not turned off, the process returns to step S301 to repeat the accumulation of the data. When it is determined in step S314 that the system is turned off, the flow ends.

In this way, a system operator can supply the past accumulated useful growth model data to a necessary user. Conversely, a user can obtain the past accumulated useful growth model data by making payment.

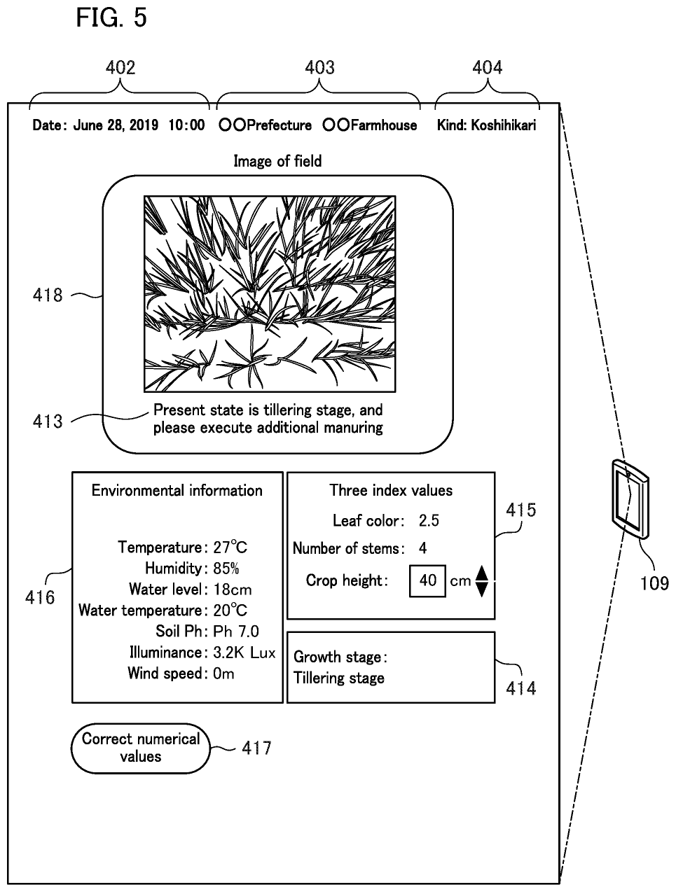

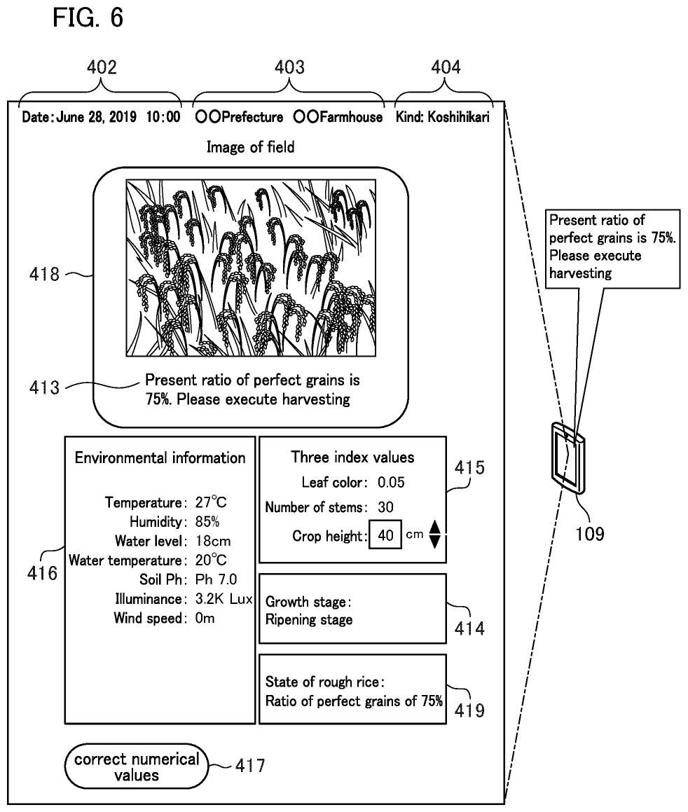

Next, a display example or the like of the growth process generated in the application server 106 will be described with reference to FIG. 4. FIG. 4 is a diagram illustrating an example of a display screen based on display data generated in the application server. FIGS. 5 and 6 are diagrams illustrating other examples of display screens.

The application server 106 acquires data necessary for the display screen from the data accumulation cloud server 105.

In FIGS. 4 to 6, reference numeral 400 denotes a display screen of the information terminal 109, reference numeral 401 denotes a graph indicating a growth process, and reference numeral 402 denotes a display region indicating a present date and time.

Reference numeral 403 denotes a display region where a charged contractor name (a contract user name or a user ID) or the like is displayed. Here, the charged contractor is a contractor that conducts a contract for supplying the accumulated growth index data, the environmental information data, growth process data, and the like to a predetermined terminal in accordance with charging.

Reference numeral 404 denotes a display region where a kind of crop is displayed, reference numeral 405 denotes a scale of the number of stems displayed on the vertical axis, reference numeral 406 denotes a scale of a crop height displayed on the vertical axis, and reference numeral 407 denotes a scale of a time axis on a monthly basis displayed on the horizontal axis.

Reference numeral 408 denotes data indicating an overall growth process (a growth stage) of rice and reference numeral 409 denotes display of an example of farm work recommended to be executed in accordance with the growth process. Reference numeral 420 denotes a scale of an SPAD value displayed on the vertical axis and reference 421 numeral denotes a scale of a leaf color before conversion into an SPAD value.

Reference numeral 410a denotes a graph indicating a growth process of a crop height and reference numeral 410b denotes a graph indicating a growth model of the crop height. Reference numeral 411a denotes a graph indicating a growth process of the number of stems and reference numeral 411b denotes a graph indicating a growth model of the number of stems.

Reference numeral 412a denotes a graph indicating a process associated with growth of the SPAD value and reference numeral 412b denotes a graph indicating a growth model of the SPAD value. Reference numeral 422 denotes display of description of a growth stage (for example, a tillering stage or the like) in accordance with the growth process of the number of stems.

Reference numerals 410a, 411a, 412a denote graphs of values calculated from images at the present imaging times. Reference numerals 410b, 411b, 412b denote graphs (growth models) modeled by accumulating past measured values or past calculated values and performing statistical processing. In accordance with such graphs, it is possible to easily compare and determine whether values calculated from captured images smoothly follow the modeled graphs (difference are small) and there are gaps

FIGS. 5 and 6 are diagrams illustrating examples of a display screen switched through menu selection or the like from the display of the graph in FIG. 4. In FIGS. 5 and 6, reference numeral 413 denotes an emphasized and displayed guide to farm work recommended to be executed at a present time.

In the display example of FIG. 5, “Present state is tillering stage, and please execute additional manuring.” is displayed. In the display example of FIG. 6, “Present ratio of perfect grains is 75%. Please execute harvesting.” is displayed.

Reference numeral 414 denotes a display region for displaying where the growth stage is located and reference numeral 415 denotes a display region where a leaf color, the number of stems, and a crop height which are three kinds of main growth index data are displayed. In this example, only the three kinds of growth index data are displayed. However, for example, other growth index data may be able to be displayed in a pull-down menu or the like.

In the first embodiment, for example, a user can appropriately correct the numbers. Reference numeral 416 denotes a display region where environmental information data is displayed as numerical values.

In the first embodiment, the temperature, the humidity, the water level of the field, the water temperature of the field, pH of the soil of the field, the illuminance, the wind speed, and the like are displayed as the environmental information data. However, for example, other environmental information data may be able to be displayed in a pull-down menu or the like.

Reference numeral 417 denotes a button for switching to a mode for correcting numerical values displayed on the screen. When the button is clicked or touched, the mode is switched to a correction mode for correcting numerical values displayed on the screen. Here, the button 417 functions as correction unit for correcting a part of the display data generated by the display data generation unit through a user input.

In the correction mode, numerical values displayed in the regions 415 and 416 can be changed. When the button 417 is clicked or touched again after the change, the correction mode is switched to a normal mode. Reference numeral 418 denotes an image of the field or an image of the crop displayed along with the graph. At least one image can be displayed. Reference numeral 419 denotes a movable marker line. The movable marker line is displayed at a position of a present date and time on the graph by default. The movable marker line can be moved with a mouse or through a touch.

For example, when stems are bent or fall due to a strong wind, a weather situation, or the like, an appropriate crop height may not be obtained from a captured image. In the correction mode, manually measured values or values measured by correcting its posture can be applied again.

For environmental information, a measured value measured again or a value from a normal sensor can be input and corrected later when an environmental information sensor is broken down.

In this way, when erroneous data is acquired as a result of image recognition, the graphs or the like of the growth process can be accordingly corrected automatically through user correction. Thus, accuracy of the graphs or the like of the growth process can be prevented from deteriorating.

When the marker line 419 is moved in FIG. 4, the date display of the region 402 is changed accordingly. When the display screen is switched to the display screen illustrated in FIG. 5 or 6 through menu selection after the movement of the marker line 419, display content of the display regions 414 to 416 or the image 418 is also changed in accordance with a date and time.

In the foregoing examples, the graphs of the growth process in FIG. 4, the images of the field in FIGS. 5 and 6, each index value, and the like are displayed on the different display screens, but FIGS. 4 and 5 or FIGS. 4 and 6 may be displayed on the same screen.

Alternatively, for example, in conjunction with the graphs of the growth process, at least one of the growth index data and the environmental information data on a predetermined date and time may be displayed along with a kind of crop.

In this way, in the first embodiment, the contract user can quickly understand the growth process of the crop in the graphs based on the environmental information data, the images of the crop acquired from the field, and the like. The contract user can quickly and easily know which farm work should be executed at a present time although the contract user does not go to the field or is a beginner of agriculture.

Next, FIGS. 7 and 8 are flowcharts illustrating an example of the above-described pairing method. FIG. 9 is a diagram illustrating an example of a table in which the association is performed.

In FIG. 7, the information terminal 109 is powered on in step S700 and an application for performing the correlation is activated in step S701. In step S702, a user ID is registered. In step S703, GPS positional information is acquired. In step S704, QR codes (registered trademark) of the plurality of sensor devices 102 are imaged with, for example, an attached camera, a camera of a smartphone, or the like.

In step S705, the imaged IDs of the plurality of sensor devices 102 are registered and displayed on a screen. In step S706, a QR code (registered trademark) of the network camera 101 are imaged with an attached camera, a camera of a smartphone, or the like. In step S707, an ID of the network cameras 101 are registered and displayed on a screen. In step S708, the GPS positional information acquired by the information terminal 109, the IDs of the plurality of sensor devices 102 and the ID of the network camera 101 are transmitted to the control server 104 together.

In step S709, an initial setting operation ends and the process proceeds to step S710 of FIG. 8. In step S710, the control server 104 preserves the registered user ID, the GPS positional information acquired by the information terminal 109, the ID of the network camera 101, the IDs of the plurality of sensor devices 102 in a table form.

Here, FIG. 9(A) is a diagram illustrating an example of a table in which the association is performed. FIG. 9(A) illustrates an example of the table in which the user ID, the information terminal ID, the GPS positional information of the sensor devices, the sensor device IDs, the network camera ID are associated.

In the example of the table, an example in which only the user ID is different and the other information is the same is shown. Here, each user ID is subscribed in a different service plan, as illustrated in FIG. 9(B).

In FIG. 9(B), a user ID (0001) is subscribed in a plan in which an image of the field is monitored and a user ID (0002) is subscribed in a plan in which the accumulated growth data can be downloaded at once. Here, the table indicating correlation of the user IDs and the service plans as in FIG. 9(B) is preserved in, for example, the service supply management server 107.

After step S710, the process proceeds to step S711 to perform the flowchart indicated in the flowchart of FIG. 3. The application server 106 detects that the user logs in the application server in step S712 and inquires of the service supply management server 107 about service information which is to be supplied to the user based on login information in step S713.

When an instruction to supply a service is given from the control server 104 during the process of step S711 in the control server 104 in step S714, the process of step S714 is performed.

That is, in step S714, data for generating display data in accordance with the service information received as a result of the inquiry in step S713 is requested and acquired from the data accumulation cloud server 105. The necessary data is acquired from the data accumulation cloud server 105 in step S715 and screen data for display is generated based on the acquired data in step S716.

The present invention has been described in detail above based on the first embodiment, but the present invention is not limited to the first embodiment and can be modified in various forms based on the gist of the present invention. The modifications are not excluded from the scope of the present invention.

For example, in the first embodiment, the environmental information data is accumulated to obtain the growth process data with high accuracy, but the environmental information data may not be accumulated in a simplified system.

When the growth process is displayed in a graph form, display data for displaying the growth process in a graph form may be generated based on the growth index data (the leaf color, the number of stems, the crop height, and the like) acquired from the images without taking the environmental information data into consideration. Further, at this time, display data for displaying the growth process may be generated using only the leaf color, the number of stems, and the crop height as growth index data.

For example, in the first embodiment, the growth process data is generated with reference to the model data learned in the model cloud server, but the growth process data may be generated simply with a prepared function (table) or the like.

In the first embodiment, the process is divided and performed by the plurality of servers. However, for example, some or all of the functions of the data accumulation cloud server 105, the application server 106, the image analysis cloud server 110, the model cloud server 111, and the like may be embedded in the control server 104.

For example, the function of the service supply management server 107 or the charging settlement server 108 may be embedded. Alternatively, the number of servers may be reduced by appropriately integrating two or more of the seven servers 104 to 108, 110, and 111.

For example, targets which are imaged with the cameras are not limited to crops and may be, for example, living things or the like including human beings.

### Second Embodiment

The various functions, processes, or methods described in the first embodiment can also be implemented by causing a server, a personal computer, a microcomputer, a central processing unit (CPU), or a microprocessor to execute a program.

Hereinafter, in a second embodiment, the server, the personal computer, the microcomputer, the CPU, or the microprocessor is referred to as a “computer X.” In the second embodiment, a program that controls the computer X and implements the various functions, processes, or methods described in the first embodiment is referred to as a “program Y.”

The various functions, processes, or methods described in the first embodiment is implemented by causing the computer X to execute the program Y. In this case, the program Y is supplied to the computer X via a computer-readable storage medium.

The computer-readable storage medium according to the second embodiment includes at least one of a hard disk device, a magnetic storage device, an optical storage device, a magneto-optical storage device, a memory card, a volatile memory, and a nonvolatile memory. The computer-readable storage medium according to the second embodiment is a non-transitory storage medium.

The aspects of the present invention have been described with reference to the foregoing embodiments, but the aspects of the present invention are construed not to be limited to the foregoing embodiments. The following claims are, of course, interpreted and harmonious in a broadest sense so that all the modification examples and equivalent configurations are included. The following claims are appended to disclose the claims of the present specification.

Priority is claimed on Japanese Patent Application No. 2019-228793, and Japanese Patent Application No. 2019-228800, both filed Dec. 19, 2019, the content of which are incorporated herein by reference.

What is claimed is:

1. An information processing device comprising:
at least one processor or circuit configured to function as:
image acquisition unit configured to acquire an image of a specific crop in a field;
environmental information acquisition unit configured to acquire environmental information data regarding an environment of the field;
index data generation unit configured to generate growth index data of the crop based on the image of the crop acquired by the image acquisition unit;
accumulation unit configured to accumulate the growth index data of a plurality of dates and times generated by the index data generation unit and the environmental information data of the plurality of dates and times; and
display data generation unit configured to generate display data for displaying a growth process based on the growth index data of the plurality of dates and times and the environmental information data of the plurality of dates and times accumulated in the accumulation unit.

2. The information processing device according to claim 1, wherein the accumulation unit also accumulates images of the crop on the plurality of dates and times.

3. The information processing device according to claim 1, wherein the display data generation unit generates display data for displaying the growth process in a graph form.

4. The information processing device according to claim 1, wherein the display data generation unit generates display data for displaying at least one of the growth index data and the environmental information data on a predetermined date and time along with the growth process and a kind of crop.

5. The information processing device according to claim 1, wherein the growth index data includes data regarding the number of stems of the crop.

6. The information processing device according to claim 1, wherein the index data generation unit counts the number of leaf apexes of the crop based on an image of the crop acquired by the image acquisition unit.

7. The information processing device according to claim 6, wherein the index data generation unit calculates data regarding the number of stems of the crop based on the number of leaf apexes.

8. The information processing device according to claim 7, wherein the growth index data includes data regarding a crop height.

9. The information processing device according to claim 8, wherein the growth index data includes data regarding a leaf color of the crop.

10. The information processing device according to claim 1, wherein the growth index data includes at least one of a vegetation rate per unit area, a proportion of stems on which ears appear to the number of stems, a proportion of ears that turn yellow, the number of ears, the number of grains of rough rice per ear, inclinations of the stems, or the degree of bending of the stems.

11. The information processing device according to claim 1, wherein the display data generation unit generates display data for displaying at least one of an image of the field on a predetermined date and time and an image of the crop along with the display data of the growth process.

12. The information processing device according to claim 1, wherein the display data generation unit generates display data for displaying at least one of a harvest time and an expectation of an amount of yield per unit area along with the display data of the growth process.

13. The information processing device according to claim 1, wherein the specific crop is a plant of Gramineae.

14. The information processing device according to claim 1, further comprising correction unit configured to correct a part of the display data generated by the display data generation unit through a user input.

15. The information processing device according to claim 13, wherein the display data generation unit generates display data for displaying information regarding a growth stage of the crop along with the display data of the growth process.

16. The information processing device according to claim 1, wherein the index data generation unit generates growth index data of the crop by comparing the growth index data and the environmental information data of the plurality of dates and times accumulated in the accumulation unit with growth model data.

17. The information processing device according to claim 1, wherein the image acquisition unit acquires an image obtained by imaging the crop at a predetermined position of the field from above.

18. The information processing device according to claim 1, further comprising charging settlement unit configured to supply the growth index data and the environmental information data accumulated in the accumulation unit to a predetermined terminal in accordance with charging.

19. The information processing device according to claim 18, wherein the charging settlement unit is capable of supplying data regarding the growth process generated based on the growth index data of the plurality of dates and times and the environmental information data of the plurality of dates and times accumulated in the accumulation unit to the predetermined terminal in accordance with charging.

20. The information processing device according to claim 1, wherein the environmental information data includes data regarding an environment of soil of the field.

21. The information processing device according to claim 20, wherein the environment of the soil includes data regarding at least one of a color of the soil of the field, an amount of moisture of the soil, a proportion of a plurality of predetermined chemical substances in the soil, and a pH value of the soil.

22. The information processing device according to claim 1, wherein the environmental information data includes data regarding weather information of the field.

23. The information processing device according to claim 1, wherein the environmental information data includes data regarding latitude and longitude of the field and includes data regarding at least one of an altitude, weather, an amount of precipitation, an amount of rainfall, an amount of snowfall, a temperature, humidity, a water level of the field, a water temperature of the field, illuminance, a sunshine duration, a wind speed, or an atmospheric pressure.

24. The information processing device according to claim 1, wherein the accumulation unit links and stores the growth index data of the crop generated based on the image of the crop with an image file.

25. The information processing device according to claim 24, wherein the accumulation unit stores the growth index data of the crop generated based on the image of the crop in a header region of the image file in accordance with a format of an EXIF standard.

26. The information processing device according to claim 24, wherein the accumulation unit stores the growth index data of the crop generated based on the image of the crop in accordance with an API format of a data platform of a WAGRI standard.

27. The information processing device according to claim 1, wherein the image acquisition unit includes a network camera that captures an image of the crop or a camera capable of performing ranging.

28. The information processing device according to claim 1, wherein the environmental information acquisition unit includes a sensor device that generates the environmental information data by measuring the environment of the field.

29. An information processing device comprising:
at least one processor or circuit configured to function as:
image acquisition unit configured to acquire an image of a crop of Gramineae in a field;
index data generation unit configured to generate index data regarding a leaf color, the number of stems, and a crop height of the crop based on the image of the crop acquired by the image acquisition unit;
accumulation unit configured to accumulate growth index data of a plurality of dates and times generated by the index data generation unit; and
growth stage data generation unit configured to generate information regarding a growth stage of the crop based on the growth index data of the plurality of dates and times accumulated in the accumulation unit.

30. An information processing device comprising:
at least one processor or circuit configured to function as:
image acquisition unit configured to acquire an image of a specific crop in a field;
environmental information acquisition unit configured to acquire environmental information data regarding an environment of the field;
index data generation unit configured to generate growth index data of the crop based on the image of the crop acquired by the image acquisition unit;
accumulation unit configured to accumulate the growth index data of a plurality of dates and times generated by the index data generation unit and the environmental information data of the plurality of dates and times; and
charging settlement unit configured to supply the growth index data and the environmental information data accumulated in the accumulation unit to a predetermined terminal in accordance with charging.

31. The information processing device according to claim 30, wherein the charging settlement unit is capable of supplying data regarding the growth process generated based on the growth index data of the plurality of dates and times and the environmental information data of the plurality of dates and times accumulated in the accumulation unit to the predetermined terminal in accordance with charging.

32. The information processing device according to claim 30, wherein the image acquisition unit includes a camera that captures an image of the crop, the camera has camera identification information, the environmental information acquisition unit includes a sensor device that generates the environmental information data by measuring the environment of the field, and the sensor device has sensor identification information.

33. A non-transitory computer-readable storage medium configured to store a computer program comprising instructions for executing following processes:
an image acquisition step for acquiring an image of a specific crop in a field;
an environmental information acquisition step for acquiring environmental information data regarding an environment of the field;
an index data generation step for generating growth index data of the crop based on the image of the crop acquired in the image acquisition step;
an accumulation step for accumulating the growth index data of a plurality of dates and times generated in the index data generation step and the environmental information data of the plurality of dates and times; and
a display data generation step for generating display data for displaying a growth process based on the growth index data of the plurality of dates and times and the environmental information data of the plurality of dates and times accumulated in the accumulation step.

34. An information processing method comprising:
an image acquisition step for acquiring an image of a specific crop in a field;
an environmental information acquisition step for acquiring environmental information data regarding an environment of the field;
an index data generation step for generating growth index data of the crop based on the image of the crop acquired in the image acquisition step;
an accumulation step for accumulating the growth index data of a plurality of dates and times generated in the index data generation step and the environmental information data of the plurality of dates and times; and
a display data generation step for generating display data for displaying a growth process based on the growth index data of the plurality of dates and times and the environmental information data of the plurality of dates and times accumulated in the accumulation step.

35. An information processing method comprising:
an image acquisition step for acquiring an image of a crop of Gramineae in a field;
an index data generation step for generating index data regarding a leaf color, the number of stems, and a crop height of the crop based on the image of the crop acquired in the image acquisition step;
an accumulation step for accumulating growth index data of a plurality of dates and times generated in the index data generation step; and
a growth stage data generation step for generating information regarding a growth stage of the crop based on the growth index data of the plurality of dates and times accumulated in the accumulation step.

36. An information processing method comprising:
an image acquisition step for acquiring an image of a specific crop in a field;
an environmental information acquisition step for acquiring environmental information data regarding an environment of the field;
an index data generation step for generating growth index data of the crop based on the image of the crop acquired in the image acquisition step;
an accumulation step for accumulating the growth index data of a plurality of dates and times generated in the index data generation step and the environmental information data of the plurality of dates and times; and
a charging settlement step for supplying the growth index data and the environmental information data accumulated in the accumulation step to a predetermined terminal in accordance with charging.

37. An information processing device comprising:
at least one processor or circuit configured to function as:
image acquisition unit configured to acquire an image of a crop;
index data generation unit configured to generate first growth index data and second growth index data different from the first growth index data based on images of the crop acquired on a plurality of different times; and
display data generation unit configured to generate display data for displaying a first growth process of the crop generated based on the first growth index data and a second growth process of the crop generated based on the second growth index data.

38. The information processing device according to claim 37, wherein the display data is display data for displaying the first and second growth processes in a graph form.

39. The information processing device according to claim 37, wherein the display data includes data for displaying the first growth process and a first growth model for comparison of the first growth process and the first growth model and for displaying the second growth process and a second growth model for comparison of the second growth process and the second growth model.

40. The information processing device according to claim 37, wherein the display data includes data for displaying information regarding a growth stage of the crop along with the first and second growth processes.

41. An information processing method comprising:
an image acquisition step for acquiring an image of a crop;
an index data generation step for generating first growth index data and second growth index data different from the first growth index data based on images of the crop acquired on a plurality of different times; and
a display data generation step for generating display data for displaying a first growth process of the crop generated based on the first growth index data and a second growth process of the crop generated based on the second growth index data.

42. A non-transitory computer-readable storage medium configured to store a computer program comprising instructions for executing following processes:
an image acquisition step for acquiring an image of a crop;
an index data generation step for generating first growth index data and second growth index data different from the first growth index data based on images of the crop acquired on a plurality of different times; and
a display data generation step for generating display data for displaying a first growth process of the crop generated based on the first growth index data and a second growth process of the crop generated based on the second growth index data.
